(19) United States
(12) Patent Application Publication
(10) Pub. No.: US 2021/0154933 A1
(43) Pub. Date: May 27, 2021

(54) DEVICE FOR SUPPORTING FILAMENT SPOOLS IN ADDITIVE MANUFACTURING SYSTEMS

(71) Applicant: SHAOXING OU AI DI MEDICAL TECHNOLOGY CO., LTD., Shaoxing (CN)

(72) Inventor: YONG LI, LaSalle (CA)

(21) Appl. No.: 17/089,256

(22) Filed: Nov. 4, 2020

(30) Foreign Application Priority Data
Nov. 5, 2019 (CN) 201921894307.5

(51) Int. Cl. B29C 64/25; B29C 64/255

(52) U.S. Cl. CPC B29C 64/25; B33Y 30/00; B29C 64/255

(57) ABSTRACT

A device for supporting filament spools comprises a rigid axle, first and second bushings, and first and second couplers for coupling the first and second bushings, respectively, to a spool. The axle has two ends and a cylindrical central section extending between the first and second ends. At least one end of the axel is configured to be supported on a support structure. The bushings are formed of a rigid material and are sized to rotatably fit over the central section of the axel. The couplers are formed of a resiliently deformable material. Each coupler has a tapered outer surface comprising a plurality of teeth for frictionally engaging one of first and second open ends of the central passageway of the filament spool and has a central bore for receiving and frictionally engaging one of the first and second bushings.

### CROSS-REFERENCE TO RELATED APPLICATIONS

The present application claims the benefits of, and priority from, Chinese Utility Model Patent Application Number CN 201921894307.5, filed Nov. 5, 2019, the entire content of which is incorporated herein by reference.

### FIELD

The present disclosure relates generally to devices for supporting spools, and particularly to devices for supporting filament spools in additive manufacturing systems.

### BACKGROUND

Additive manufacturing is also commonly referred to as three-dimensional (3D) printing. Additive manufacturing technology typically includes various processes to deposit, cure, fuse, or otherwise form layers in sequence to form a 3D object.

The material to be printed in such systems may be fed to the 3D printer as a continuous filament using a filament spool so the filament can be smoothly fed to the 3D printer for printing 3D objects.

For example, the 3D objects may be printed in a layered manner using fused deposition modeling (FDM) techniques. The printing material of an FDM type 3D printer is usually supplied in a solid form of filament and the filament is held on a spool. The diameter of the filament may be 1.75 or 2.85 mm for most FDM type 3D printers currently in use. A typical FDM type 3D printer has a printing head with a feeding gear driven by a motor. During a printing run, the feeding gear pulls the filament from the spool into the printing head. The diameter of feeding gear for many FDM type 3D printers is less than 12 mm. The outside diameter of a typical filament spool current in use is about 200 mm. Existing filament spools for FDM 3D printing can often support up to 5 Kg of the filament material. The filament spools available on the market usually do not include integrated actuation mechanism for motorizing the spools so the spools will only rotate when they are actuated by an external force, such as by being pulled, through the filament on the spool, by the feeding gear of the 3D printer.

As the printer head of a 3D printer typically has a relatively small size, the size of the feeding gear and the pulling force it can generate is also limited. When using a small feeding gear to pull a filament supported on a relatively large spool carrying up to 5 Kg weight, it would be desirable to reduce the rotational resistance on the spool.

A typical filament spool 110 is shown in FIG. 1A, which has a tubular cylinder for winding the filament 106 around it and two flanges at each end of the cylinder for confining the wound filament. Various filament spool holders for supporting spools to feed filaments to 3D printers are available. Some existing filament spool holders can support spools of different sizes. However, existing spool holders have one or more of various disadvantages or drawbacks. For instance, some existing filament spool holders produce relatively high surface friction between moving and non-moving parts, thus exhibiting relatively high rotational resistance during operation. With some existing filament spool holders, the supported filament spool rotates about a rotation axis that is offset from, or not aligned with, the central axis of the spool, so the spool may swing about and is not stable. Unstable, or interruption in, filament feeding can lead to poor quality of the printed objects, or even complete printing failure.

Filament spools of different sizes can carry different amounts of filament. Typically, filaments on spools are provided in amounts of 0.5 kg to 5 kg.

As can be appreciated, a filament spool typically has a central passageway for allowing a support axle to pass and may be simply rotatably supported on an axle with a diameter smaller than the diameter of the central passageway of the spool. However, if the axle's size does not fit closely with the size of the passageway, the spool rotation would not be stable and smooth and a larger torque would be required to drive the rotation due to the axial offset between the axis of the axle and the axis of the spool. In such a case, the rotation stability is particularly poor when the filament is made of a flexible material.

An improved conventional technique for supporting filament spools is to provide bearings to support the spool at the spool flanges. For example, as shown in FIG. 1A, a known spool support 200 has bearings 212 mounted on a base 208. Two bearings 212 are used to support each spool flange of the filament spool 110. However, with support by such bearings the spool 110 can still wobble during operation due to deformation of the spool flanges or cylinder. In addition, when the amount of the filament left on the spool is small and thus light, the pulling force can cause the spool 110 to tumble or even fall down from the spool support 200, which may result in premature termination of a print job and a failed print.

It is therefore desirable to provide improved devices and technique for supporting filament spools in additive manufacturing systems. For example, it is desirable to provide devices for supporting filament spools of different sizes and providing stable and smooth feeding of the filament.

### SUMMARY

Accordingly, the present disclosure discloses devices for supporting filament spools of different sizes in additive manufacturing systems and providing relatively stable and smooth feeding of the filament.

An embodiment disclosed herein may be provided as a free-stand, desktop device. For example, a filament holder disclosed herein may be placed beside a 3D printer for supporting a filament spool to feed filaments to the 3D printer. In some embodiments, the device may be attached to or mounted on the 3D printer as a filament holder. In further embodiments, a device as disclosed herein may be mounted onto a vertical wall or panel, or below a ceiling, for supporting the filament spool and feeding filaments to a 3D printer.

In an aspect of the present disclosure, there is provided a device for supporting filament spools in additive manufacturing systems, comprising a rigid axle sized to pass through a central passageway of a filament spool, the axle comprising first and second ends and a cylindrical central section extending between the first and second ends, at least one of the first and second ends configured to be supported on a support structure that supports the axle and the filament spool and restricts rotation of the axle; first and second bushings formed of a rigid material, the first and second bushings sized to rotatably fit over the central section of the axel; and first and second couplers for coupling the first and second bushings, respectively, to the central passageway of the spool, the first and second couplers formed of a resiliently deformable material, wherein each one of the first and second couplers has a tapered outer surface comprising a plurality of teeth for frictionally engaging one of first and second open ends of the central passageway of the filament spool, and has a central bore for receiving and frictionally engaging one of the first and second bushings.

In selected embodiments of the device described in the preceding paragraph, one or more of the following features may be provided. The device may include the support structure, such as being provided in a kit or the same package. The support structure may comprise a base body, and two arms extending from the base body each for supporting one of the first and second ends of the axle. The teeth may be straight bevel gear teeth. Each one of the first and second couplers may have an outer diameter from 10 mm to 400 mm. The resiliently deformable material of the first and second couplers may have a Shore hardness less than 95A. The rigid material of the first and second bushings may have a Shore hardness of more than 75D. The rigid material may be one of nylon, aluminum, steel, and copper. Each one of the first and second bushings may comprise a cylindrical central channel, which may have a diameter of from 6 mm to 200 mm. The axle may be configured to be supported at one of the first and second ends of the axle. The axle may be configured to be supported at both of the first and second ends. The base body may comprise a plurality of through holes for mounting the base body. The each one of the first and second arms may comprise a plurality of slots, each one of the slots configured to receive and support one of the first and second ends of the axle. At least one of the slots may be oriented and configured to support the axle above the base body when the first and second arms are vertically oriented. At least one of the slots may be oriented and configured to support the axle at a side of the base body when the first and second arms are horizontally oriented. At least one of the slots may be oriented and configured to support the axle below the base body when the first and second arms are inversely vertically oriented. The support structure may comprise a rigid material selected from an alloy, steel, aluminum, and a plastic material. The support structure may comprise a generally U-shaped panel having a thickness of from 0.5 mm to 20 mm. The tapered outer surface of each one of the first and second couplers may comprise a plurality of teeth for engaging the open end of the filament spool.

In another aspect of the disclosure, there is provided a support structure for supporting a device described here. The support structure comprises a rigid panel bent into a generally U-shaped profile, comprising a central base body and two arms extending from the base body, a terminal end of each one of the arms comprising a plurality of slots configured to engage and support one of the first and second ends of the axle, wherein the base body comprising a plurality of through holes for mounting the base body; at least one of the slots is configured to support the axle above the base body when the first and second arms are vertically oriented; at least one of the slots is oriented and configured to support the axle below the base body when the first and second arms are inversely vertically oriented; and at least one of the slots is oriented and configured to support the axle at a side of the base body when the first and second arms are horizontally oriented.

Other aspects, features, and embodiments of the present disclosure will become apparent to those of ordinary skill in the art upon review of the following description of specific embodiments in conjunction with the accompanying figures.

### BRIEF DESCRIPTION OF THE DRAWINGS

In the figures, which illustrate, by way of example only, embodiments of the present disclosure:

FIG. 1 is a perspective schematic view of a three-dimension (3D) printer with a filament spool;

FIG. 1A is a perspective view of the filament spool supported on a conventional spool support;

FIG. 2 is a perspective view of a filament spool carrying a filament thereon;

FIG. 3 is a perspective view of the filament spool of FIG. 2 without the filament;

FIG. 4 is a perspective sectional view of the filament spool of FIG. 3;

FIG. 5A is a perspective view of a spool holder, in accordance with an embodiment of the present disclosure;

FIG. 5B is an exploded view of the parts of the spool holder of FIG. 5A;

FIG. 5C is a side view of the spool holder of FIG. 5A;

FIG. 5D is a perspective cross-sectional view of the spool holder of FIG. 5A, taken along the line 5D-5D in FIG. 5C;

FIG. 6 is a perspective view of a coupler in the spool holder of FIG. 5A;

FIG. 7 is a perspective view of a bushing in the spool holder of FIG. 5A;

FIG. 8A is a perspective view of the spool holder of FIG. 5A oriented in a vertical direction and a filament spool top mounted on top of the spool holder, according to an embodiment of the present disclosure;

FIG. 8B is an exploded view of the spool holder and filament spool of FIG. 8A;

FIG. 9 is a perspective view of the spool holder and spool of FIG. 8A mounted on top of the 3D printer, according to an embodiment of the present disclosure;

FIG. 10 is a perspective view of the spool holder of FIG. 5A oriented in a horizontal direction and a filament spool mounted on a side of the spool holder, according to an embodiment of the present disclosure;

FIG. 11 is a perspective view of the spool holder and spool of FIG. 10 mounted on the side of a vertical panel beside the 3D printer, according to an embodiment of the present disclosure;

FIG. 12 is a perspective view of the spool holder of FIG. 5A oriented in an inversed vertical direction and a filament spool mounted below the spool holder, according to an embodiment of the present disclosure;

FIG. 13 is a perspective view of the spool holder and spool of FIG. 12 mounted underneath a horizontal panel above the 3D printer, according to an embodiment of the present disclosure;

FIG. 14 is a perspective view of the spool holder and spool of FIG. 8A mounted on a stand, according to an embodiment of the present disclosure;

FIG. 15 is a perspective view of the spool holder and spool on the stand of FIG. 14 beside the 3D printer, according to an embodiment of the present disclosure;

FIG. 16 is a perspective view of another spool holder with a cantilever configure, according to an embodiment of the present disclosure;

FIG. 17 is an exploded view of the spool holder of FIG. 16;

FIG. 18 is a perspective view of the spool holder of FIG. 16 with a filament spool mounted thereon, according to an embodiment of the present disclosure;

FIG. 19 is an exploded view of the spool holder and spool of FIG. 18;

FIG. 20 is a perspective view of the spool and spool holder of FIG. 19 mounted on a side of a 3D printer, according to an embodiment of the present disclosure; and

FIG. 21 is a perspective view of an alternative construction of a coupler, according to an embodiment of the present disclosure.

### DETAILED DESCRIPTION

In overview, it has been recognized that when a spool holder has tapered couplers (e.g. generally cone-shaped) for coupling a filament spool to the axel of the spool holder, it is convenient to mount spools of different sizes on the same axle. When the couplers are resiliently deformable and have teeth on their outer surfaces and are coupled to the axle of the spool through rigid bushings, stable and smooth rotation of the filament spool can be conveniently achieved.

Further, a spool holder support structure may be provided for mounting the spool holder in various orientations and configurations.

Embodiments disclosed herein may be used for supporting filaments spools used in additive manufacturing systems.

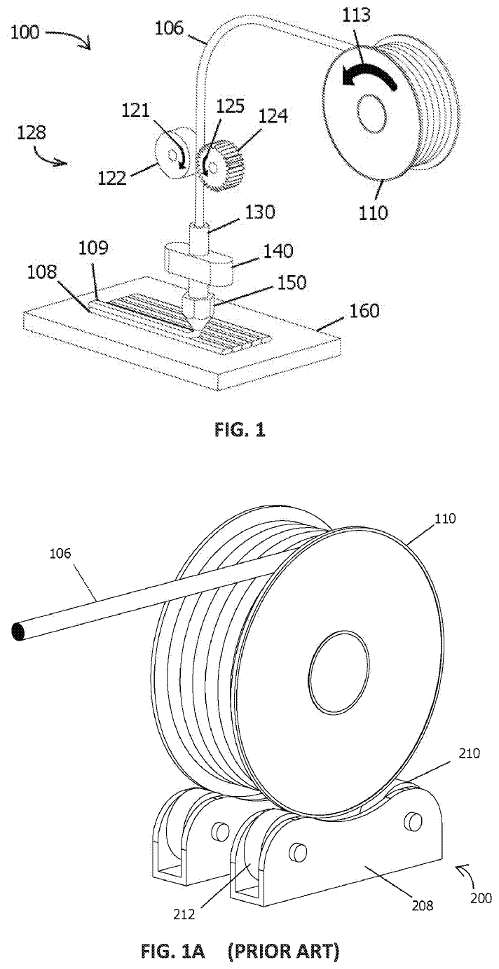

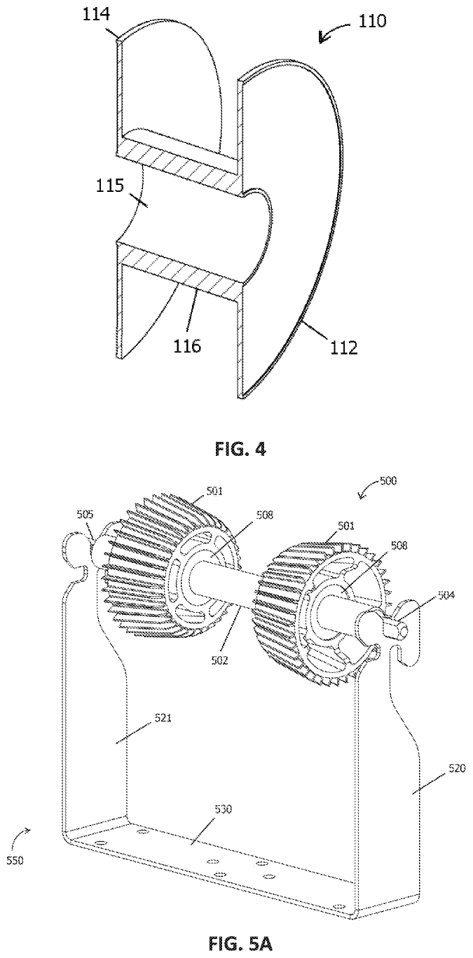

One or more filament feeding problems may arise if the filament is mounted on a conventional spool. Such problems are illustrated using the 3D printing device depicted in FIGS. 1 to 4.

FIG. 1 illustrates view of an example additive manufacturing system using a filament spool. For illustration purpose, the system as depicted in FIG. 1 is a fused deposition modeling (FDM) type 3D printer 100. A filament 106 is carried on a filament spool 110. The diameter of the filament 106 may be 1.75 or 2.85 mm.

3D printer 100 includes a horizontal build plate 160. The printing material is provided by a filament 106, which is wound around a filament spool 110. The 3D printer 100 has an electro-mechanical printing head 128. The printing head 128 has a pulling gear 124, a roller 122, a heating chamber 130, a heater 140 and a nozzle 150. The parts and constructions of the 3D printer 100 are known to those skilled in the art and will not be described in detail.

Example FDM type 3D printing devices and techniques are described in, for example, U.S. Pat. Nos. 4,749,347 and 5,121,329, the entire contents of which are incorporated here by reference.

The filament, or the print material, may be any material that is suitable for printing a 3D object using additive manufacturing techniques. For example, the print material may have properties and characteristics that are suitable for being continuously fed to an extruder to be softened or melted and then extruded or otherwise emitted from a nozzle or printing head to be deposited on a surface, and can then cure or harden. Different materials may be printed at the same or different types and may be provided in the same or different filaments. Suitable print materials may include the so-called “build material” that forms permanent portions of a 3D-printed object and a “support material” that forms temporary structures to support portions of the already printed build material during a 3D printing process. The support material can be optionally removed after completion of the printing process. Examples of suitable print materials include acrylonitrile butadiene styrene (ABS), polylactic acid (PLA), polyethylene terephthalate glycol (PETG), polyamide (PA), polyvinyl alcohol (PVA), thermoplastic polyurethane (TPU), and the like. Other materials capable of forming solid objects by extrusion may also be used. The print material may be supplied as a continuous elongated filament of a circular cross-section. The filament may have a diameter ranging from 1.5 to 3.5 mm, or a larger or smaller diameter. The filament is typically provided and available on a filament spool.

During use, the filament 106 is fed to the printing head 128 and then deposited as a thin layer of melt filament 109 onto the build plate 160. Generally, the filament 106 is melted in the heating chamber 130 and extruded out of the nozzle 150. For printing each layer, the nozzle 150 is controlled to move horizontally in the X and Y directions as the melted print material is extruded so as to deposit a desired pattern of the melted print material on the base plate or on top a previously printed layer. The newly printed layer then cools and hardens. Thus, layer by layer, the printed material or layers are stacked in the vertical direction (Z axis) to form a 3D object. By controlling the movement of the nozzle 150 and the rate of extrusion of the print material, the printed 3D object may have any desired shape.

The print material is melted when the temperature of the print material is increased, such as by heating, to above the melting point of the material. The print material does not need to be completely melt and transform into a liquid phase. It is sufficient if filament or print material is softened, or changes its phase, so the material can be extruded or printed through a nozzle or a printing head.

The printing head of a 3D printer may include an extruder. An extruder may have a heater for melting the filament in a chamber of the extruder and may have a nozzle for extruding the melted print material. A nozzle typically has an orifice or opening with a suitable size for extruding the print material in an adequate amount or rate for 3D printing. From the opening of nozzle, the melt filament is emitted as a continuous linear stream. The dimension of the nozzle orifice or opening can affect the width of the printed or extruded material while the nozzle is moving in a horizontal direction.

The pulling gear 124 can be driven by a step motor (not shown) to rotate and pull the filament 106 into the heating chamber 130. This pulling action will cause the filament spool 110 to rotate in the direction as indicated by the arrow 113. The filament 106 can thus be continuously fed to the printing head 128 for printing. After the filament 106 is heated by the heater 140, the filament melts in the heating chamber 130 and is expelled from the nozzle 150 to form a stream of melt material 109, which is deposited on the build plate 160 or on top of a previously deposited layer 108.

As shown in FIG. 1, the filament 106 is engaged with both the pulling gear 124 and the roller 122. The pulling gear 124 is driven to rotate in the direction as indicated by the arrow 125. In this embodiment, the roller 122 is not driven or actuated by a motor and can rotate freely around its rotation axis. The pulling force is mainly applied to the filament 106 by the teeth on the pulling gear 124. This pulling force causes the filament spool 110 to rotate in the direction of the arrow 113 as depicted in FIG. 1. The rotation of the pulling gear 124 draws more filament 106 from the filament spool 110 towards the printing head 128. The pulling gear 124 may have an outer diameter ranging from 6 to 25 mm.

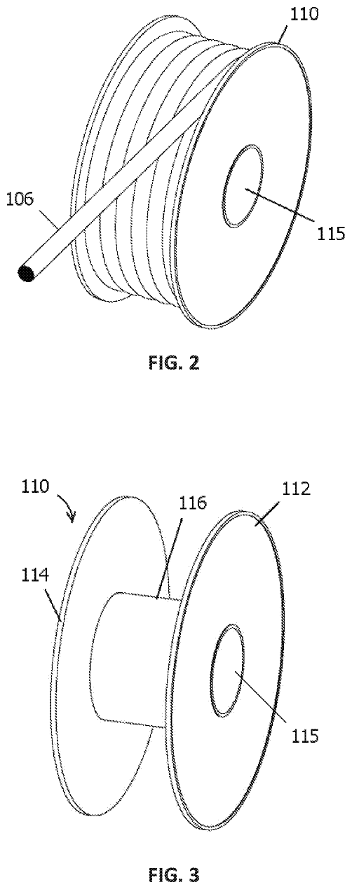

A typical filament spool 110 for use on 3D printer 100 is further illustrated in FIGS. 2 to 4. As depicted, the filament spool 110 includes a tubular cylinder, referred to as the central hub 116 herein, and two opposite flanges at each end of the cylinder, referred to as walls 112, 114. The opposite walls 112, 114 are connected by the central hub 116 and extend radially from the center hub 116. Hub 116 defines a cylindrical central passageway 115. The space formed between the walls 112, 114 around the hub 116 can accommodate windings of the filament 106.

The outer diameters of the flanges or walls 112, 114 of the filament spool 110 may be from 75 mm to 500 mm. The filament material carried on the filament spool 110 may be from about 0.5 kg to about 5 kg.

As can be appreciated by those skilled in the art, filament spools available on the market have various dimensions and shapes and are made of different materials. For example, commercially available filament spools may have an outer diameter (diameter of walls 112, 114) varying from 75 to 500 mm. The length of the central hub 116 between the walls 112, 114 may vary from 45 mm to 600 mm. The outer diameter of the center hub 116 may vary from 20 mm to 100 mm. The diameter of the cylindrical passageway 115 may vary from 15 mm to 95 mm.

The present inventor recognized that when the filament is pulled, such as by the pulling gear 124, the filament spool supported on a conventional spool holder can be subjected to relatively high rotational or frictional resistance, which prevents the spool from rotating freely, the feeding of the filament 106 to the printing head 128 might become unstable, such as being reduced in speed, or suspended, leading to under-feeding of the filament 106. With less filament 106 being fed into the printing head 128, there will be less filament material emitting from the nozzle 150. The inter-layer bonding of a 3D object printed under such a condition will be much weaker and in most cases the printing will fail due to insufficient printing material for forming a continuous layer.

Another problem that may arise is that the pulling gear 124 generates much less pulling force on flexible filaments or filaments with a slightly smaller diameter, as compared with rigid filament materials and larger filament sizes.

It has also been recognized by the present inventor, it is desirable to have a filament spool mounting devise that exhibits reduced or minimum frictional resistance during rotation of the spool. It is also desirable that the spool mounting or supporting device can work with various types of filaments, including regular rigid filaments, flexible filaments and filaments with a small diameter such as a diameter of 1.5 mm to 2 mm.

To address one or more of these and other issues discussed herein, a device for rotatably supporting the filament spool 110 is provided, according to an example embodiment of the present disclose. The device includes a rigid axle sized to pass through a central passageway of a filament spool. The axle has first and second ends and a cylindrical central section extending between the first and second ends. At least one of the first and second ends is configured to be supported on a support structure that supports the axle and the filament spool and restricts rotation of the axle. Two bushings formed of a rigid material are also provided, which are sized to rotatably fit over the central section of the axle. Two couplers are provided for coupling the bushings respectively to the central passageway of the spool. The couplers are formed of a resiliently deformable material and have a tapered outer surface and teeth for frictionally engaging the open ends of the central passageway of the filament spool. Each coupler also has a central bore for receiving and frictionally engaging one of the bushings.

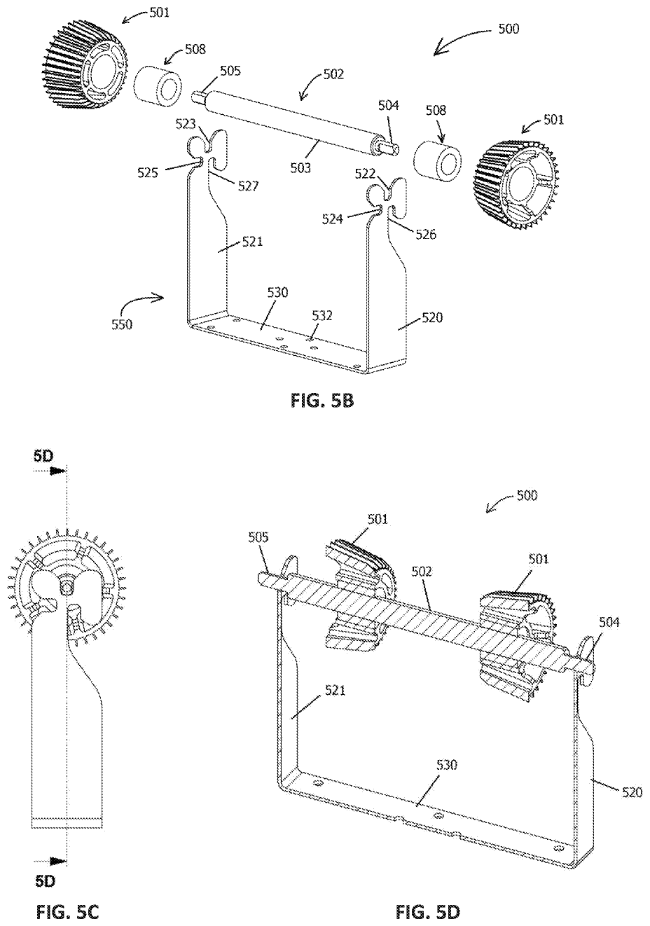

An example embodiment of such a device is illustrated in FIGS. 5A, 5B, 5C and 5D.

As illustrated in FIGS. 5A-5D, a device 500 for supporting the filament spool 110 includes a pair of flexible couplers 501, a pair of rigid bushings 508, a rigid axle 502, and a support structure 550.

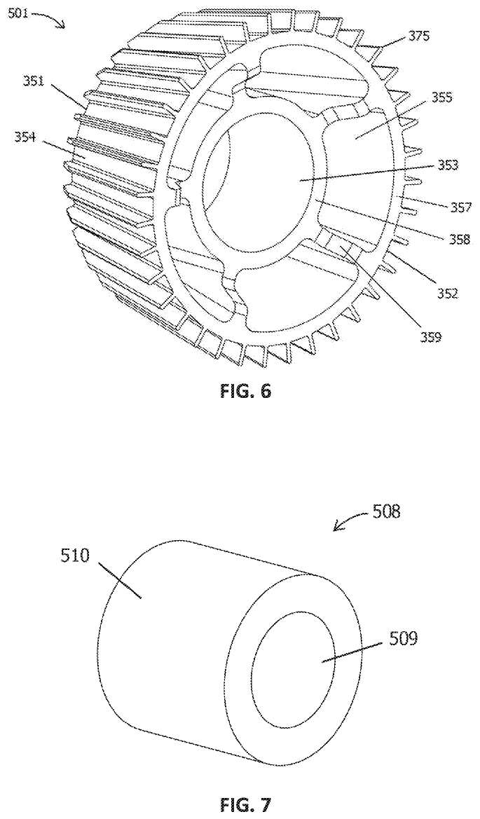

The couplers 501 are made of a resiliently deformable material. The resiliently deformable material may be a rubber material or have rubber-like properties. The material may have a hardness less than Shore 95A. The flexible coupler 501 is sized and configured to tightly fit into the open ends of the central passageway 115 of the filament spool 110. When assembled, couplers 501 will rotate with the filament spool 110 and there is ideally no relative movement between the couplers 501 and the hub 116 of the filament spool. Thus, as better illustrated in FIG. 6, each coupler 501 has a number of teeth 375 on its outer surface 354 for improving frictional engagement with the inner surface of the hub 116 of the filament spool 110. To allow the couplers 501 to tightly fit into the central passageway 115 of the spool 110 with various diameters, the outer surface of the coupler 501 is tapered, and the coupler 501 may have a generally cone-shaped profile or a conical shape. That is, one end, end 351, of the coupler 501 has a smaller outer diameter and the other end, end 352, of the coupler 501 has a larger diameter. The outer diameters of the couplers 501 may vary from 10 mm to 120 mm. The difference between the diameters of the opposite ends 351 and 352 may be from 2 mm to 75 mm. The length between ends 351 and 352 may vary from 10 mm to 100 mm. Each coupler 501 has a central bore 353 sized for receiving and frictionally engaging the bushing 508. The teeth 375 may have a tooth thickness of 0.5 mm to 10 mm and a height of 1 mm to 50 mm. The teeth 375 may deform when the coupler 501 is inserted into the passageway 115 of spool 110 so as to improve frictional engagement and provide a firm fit. Coupler 501 may have 3 to 100 teeth 375. As teeth 375 are not used for gear transmission, they do not have to have tooth shapes required for gear teeth, but they may have a similar general structure and configuration to gear teeth such as bevel gear teeth, particularly straight bevel gear teeth. Each tooth 375 may be configured as a thin wall structure radially extending outwards from the outer surface 354 of coupler 501. The teeth 375 may be generally parallelly aligned on the outer surface 354 of coupler 501.

Coupler 501 includes hollow sections 355 between the outer rim 357 and the inner rim 358 and a number of reinforcing ribs 359 extending from the inner rim 358 to the outer rim 357. Ribs 359 may be evenly distributed around the circumference of the rims 357 and 358. Inner rim 358 may also be recessed inwardly with respect to outer rim 357, as illustrated in FIG. 6. Providing hollow sections 355 and recessed inner rim 358 in couplers 501 can reduce the weight of the couplers and the materials used. A lighter weight may reduce the load on pulling gear 124 for rotating the spool 110 during operation. Reduced materials can reduce manufacturing costs.

The bushing 508 is further illustrated in isolation in FIG. 7. Bushing 508 is made of a rigid material, which may be nylon or aluminum or the like. Bushing 508 has a generally tubular shape with an outer cylindrical surface 510 and an inner cylindrical bore 509. The outer diameter of bushing 508 may be larger than its inner diameter by 1 mm to 60 mm. In other words, the tubular wall of bushings 508 may have a thickness of 0.5 mm to 30 mm. The outer diameter of bushing 508 and the inner diameter of coupler 501 should match so that bushing 508 can tightly fit into the coupler 501 and when assembled there is no relative movement between each pair of the coupler 501 and bushing 508.

During assembly, each bushing 508 may be pushed into the bore 353 of a corresponding coupler 501 to form a tight-fit and engagement. Each pair of engaged bushing 508 and coupler 501 will rotate together during operation. The inner cylindrical surface 509 of busing 508 may have a diameter larger than the diameter of the cylindrical central section of the axle 502, such as by about 0.2 mm to about 10 mm. As a result, the axle 502 can be easily slid into the central bore 509 of bushing 508 to form a loose fit and the bushing 508 can rotate around the axle 502 when the axle is fixed in position and does not rotate.

Axle 502 may be made of a rigid material such as nylon, aluminum, steel, or the like. The rigid axle 502 is fixedly mounted on the support structure and prevented from rotation around its longitudinal axis. The length of the axle 502 may vary from 50 mm to 750 mm. The diameter of the cylindrical central section 503 of the axle may be from 10 mm to 100 mm. The dimensions of the axle may also be varied or selected depending on the spools to be supported and the bushings 508 used.

Axle 502 has two ends 504 and 505, which may have two or more flat faces. The flat faces at the ends 502, 504 can be used to prevent rotation of the axle 502 when the ends 502, 504 are received in the slots of the support arms 520, 521.

In a particular embodiment, the axle 502 can be supported at both ends 504 and 505 by a generally U-shaped support structure 550 as illustrated in FIGS. 5A-5C.

As better seen in FIG. 5B, the generally U-shaped support structure 550 has two support arms 520, 521 and a base plate 530 interconnecting the support arms 520, 521. The support arms 520, 521 extending from one side of the base plate 530. The base plate 530 has mounting holes 532 for mounting the support structure to a wall panel, a printer, or a stand. Mounting holes 532 are through holes and may be threaded or non-threaded. The support structure 550 may be formed of different parts welded together or may be bent from a single piece of material or molded. The U-shaped support structure 550 may be made of steel, aluminum, a rigid plastic material, or the like.

The support arms 520, 521 extend from the ends of the base plate 530 and are generally parallel to each other. Support arms 520, 521 as depicted are elongated panels with a generally rectangular cross-section. However, in different embodiments, they may have different shapes.

In some embodiments, each support arm 520, 521 has three slots, 522, 524, 526 and 523, 525 and 527 respectively, at the terminal end of the art, which form a “hand” for holding an end 504, 505 of the axle 502. The slots may be formed as cutouts.

Slot 522, 523 is on the top, or far end, of the arm 520, 521 and faces away from base plate 530. Slot 524, 525 is facing outwardly from a side of the arm 520, 521. Slot 527, 526 faces towards the base plate 530.

Device 500 may be configured in different manners to mount and support the filament spool 110 for feeding filament to 3D printer 100.

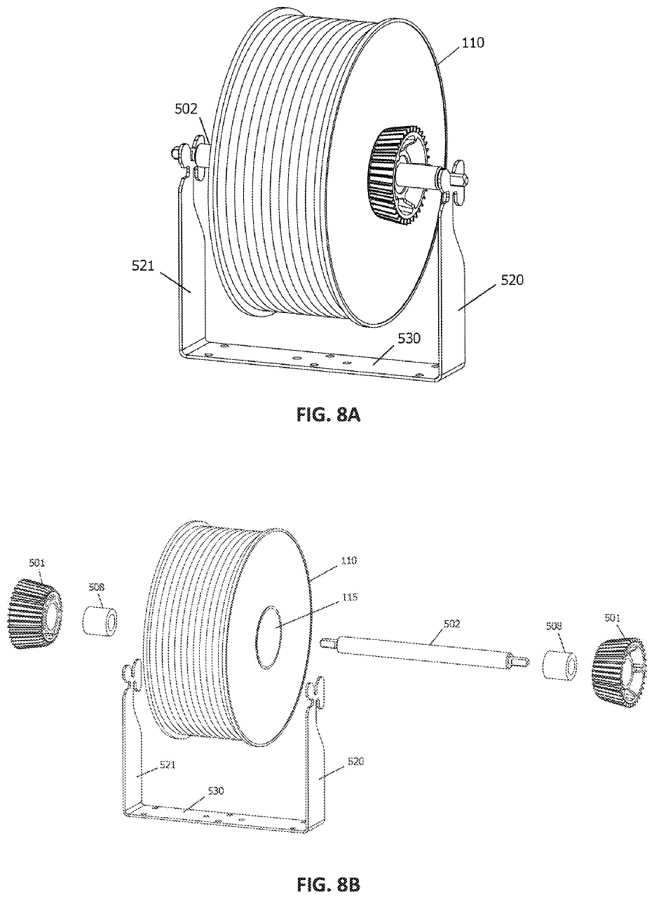

For example, the slots 522 and 523 may be identical in shape and size and may be sized and positioned to receive the ends 504, 505 of the axle 502 respectively. Thus, the filament spool 110 can be held above the support structure 550 as the support structure 550 is in an upright orientation, as shown in FIG. 8A. FIG. 8B shows an exploded view of the device 500 and filament spool 110 in this configuration.

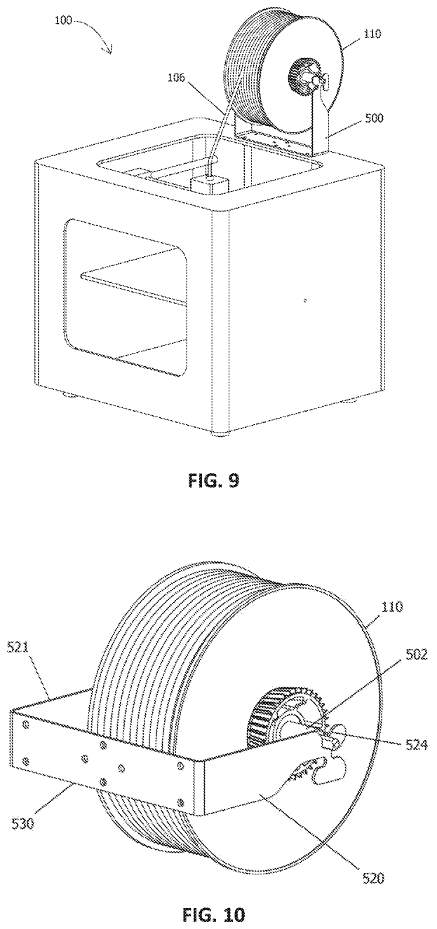

The upright arrangement of the spool 110 and device 500 as shown in FIG. 8A can be mounted on top of a 3D printer as illustrated in FIG. 9.

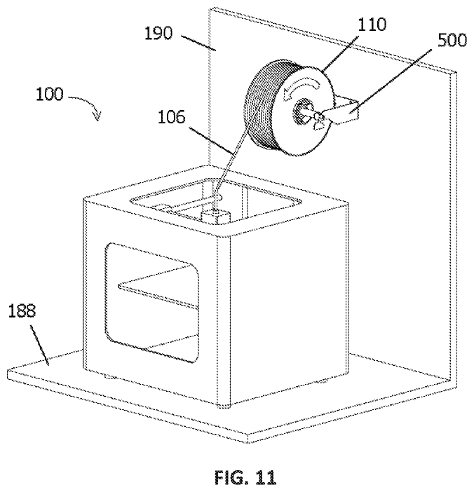

The slots 524 and 525 may be identical in shape and size and may be sized and positioned to receive ends 504, 505 of the axle 502 respectively. The filament spool 110 may be supported using slots 524, 525 with the support structure 550 oriented horizontally as illustrated in FIG. 10. As illustrated in FIG. 11, the arrangement of the spool 110 and device 500 shown in FIG. 10 may be mounted on a wall panel 190 beside the 3D printer 100. Wall panel 190 and 3D printer 100 may be placed on a desktop 188, or any other support surface. Wall panel 190 may extend vertically from the desktop 188.

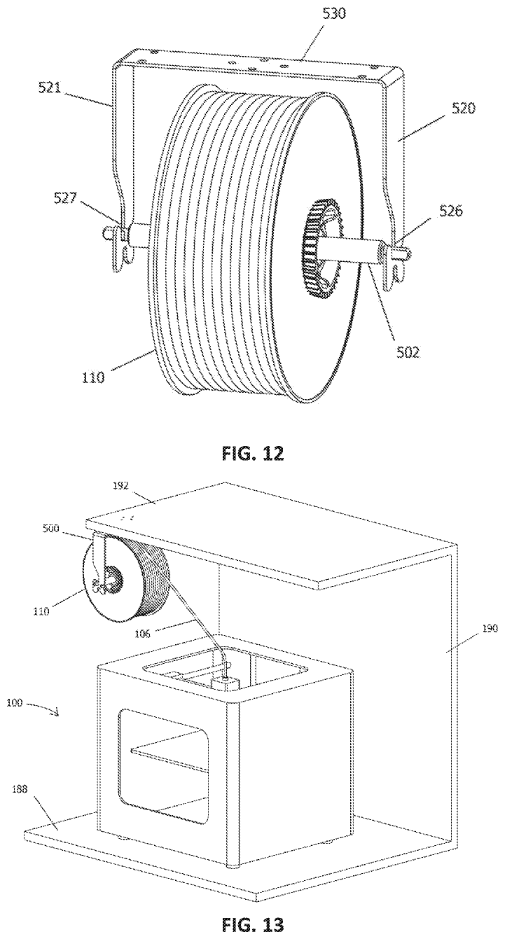

In some embodiments, slots 526 and 527 may be identical in shape and size and may be sized and positioned to receive the ends 504, 505 of the axle 502. As illustrated in FIG. 12, the support structure 550 may be oriented in an inverted vertical direction, or upside down, and slots 526 and 527 may be used in this orientation to receive and support the axle 502 and in turn support the spool 110 below the base plate 530. In other words, the support structure 550 functions as a hanger in this configuration. The spool 110 is hanging below the base plate 530, and slots 526, 527 of arms 520, 521 function as hooks. As illustrated in FIG. 13, the arrangement of the spool 110 and device 500 in the configuration shown in FIG. 12 may be mounted on an overhanding wall 192 above the 3D printer 100. Overhanging wall 192 may extend horizontally from the vertical wall panel 190, which in turn extends vertically from the desktop 188.

In an alternative embodiment, device 500 in the upright configuration may be mounted and supported any horizontal surface or support, and may be used as a free-stand filament holder in proximity of the 3D printer 100, without being physically affixed to the 3D printer 100, or to a wall or a ceiling.

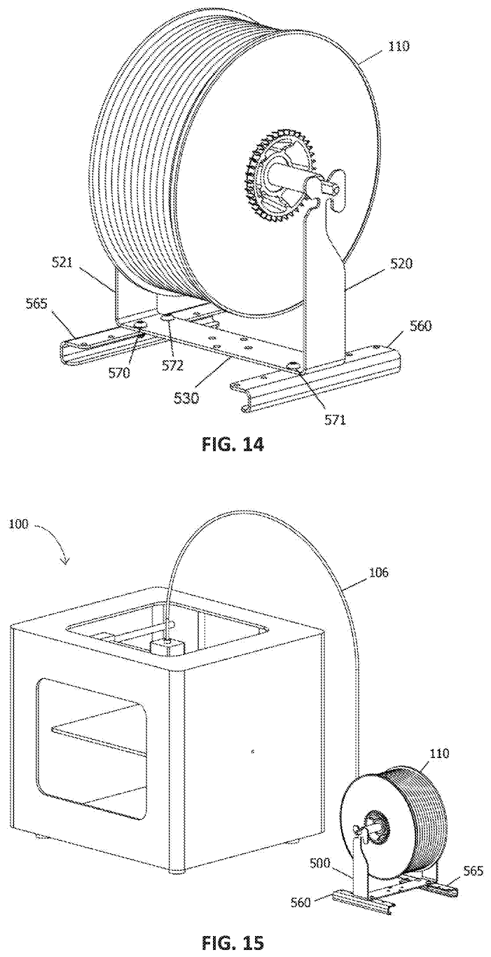

In some embodiments, device 500 in the upright configuration may be mounted on a stand, or rails or tracks. For example, as illustrated in FIG. 14, the based plate 530 may be affixed to two rails 560 and 565. Rails 560 and 565 may have generally U-shaped profiles and may have threaded screw holes or unthreaded bolt holes. Base plate 530 may be mounted on the rails 560, 565 with crews or bolts and nuts. As depicted in FIG. 14, rail 560 is mounted under support arm 520 with two screws (only one screw 571 is visible in FIG. 14), and rail 565 is mounted under support arm 521 with two screws 570, 572. As illustrated in FIG. 15, the device 500 and supported filament spool 110 in such a configuration may be conveniently placed beside or close to the 3D printer 100, and its position may be conveniently adjusted.

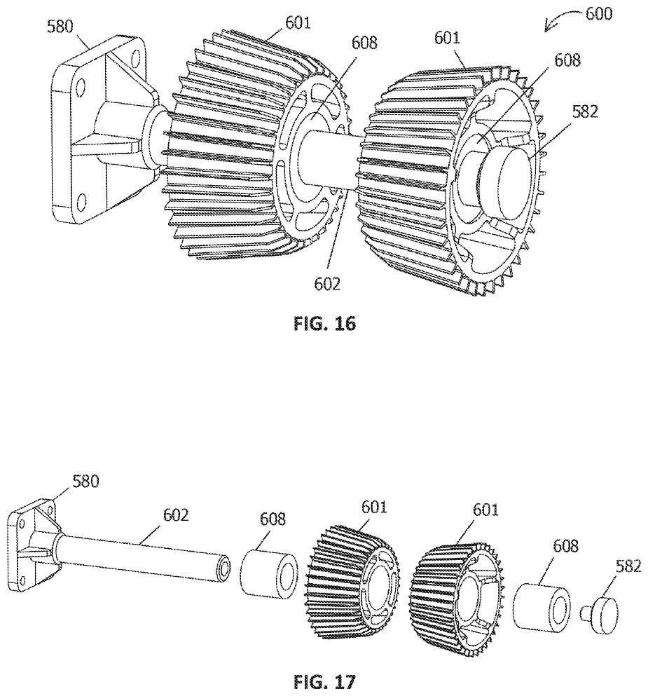

FIGS. 16 and 17 illustrate an alternative embodiment, device 600, for supporting filament spools. Device 600 includes two couplers 601 and two bushings 608, which are similarly constructed as couplers 501 and bushings 508 in device 500. Device 600 also includes a rigid axle 602 with cylindrical ends and a support structure for supporting the axle 602 at one of its two ends, in a cantilever configuration. The support structure of device 600 includes a mount bracket 580. Bracket 580 has a base having screw or bolt holes for mounting the bracket 580 to a wall or vertical panel and horizontally oriented bore for receiving one of the two ends of the axle 602. Device 600 also includes a stopper 582, which is configured and used to fit over the free-hanging end of the axle 602 to prevent the couplers 601 and bushings 608 from slipping or sliding off the free-handing end of axle 602. For this purpose, the free-hanging end of axle 602 has an inner bore for receiving the stopper 582. Stopper 582 has a plugging protrusion that fits tightly within the inner bore of the axle 602 and frictionally engages the axle 602.

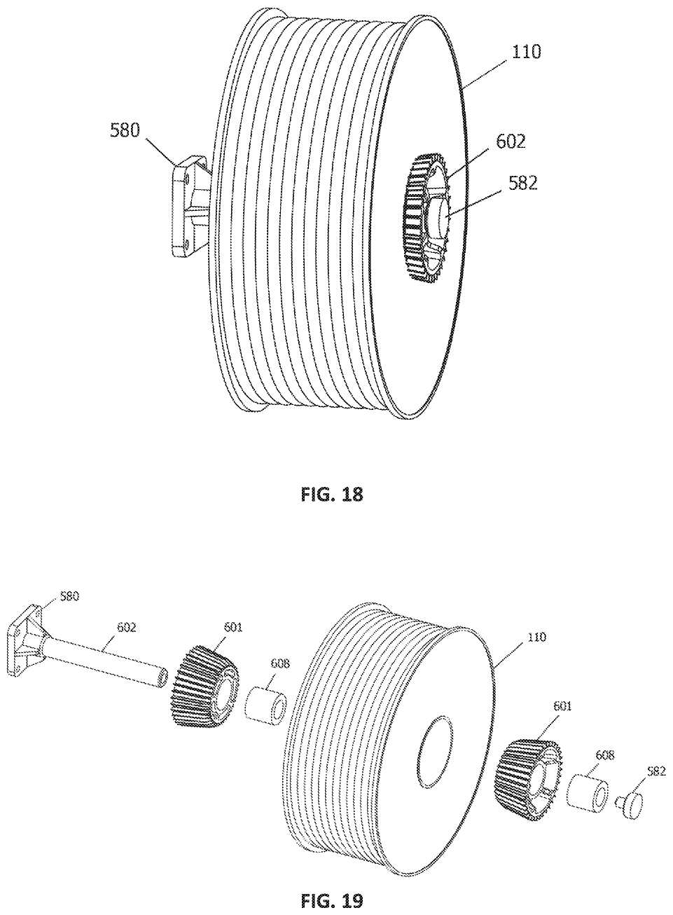

The filament spool 110 may be supported on device 600 as illustrated in FIG. 18 when device 600 is mounted on a side wall (not shown). FIG. 19 shows an exploded view of components of FIG. 18 and how they may be assembled or mounted.

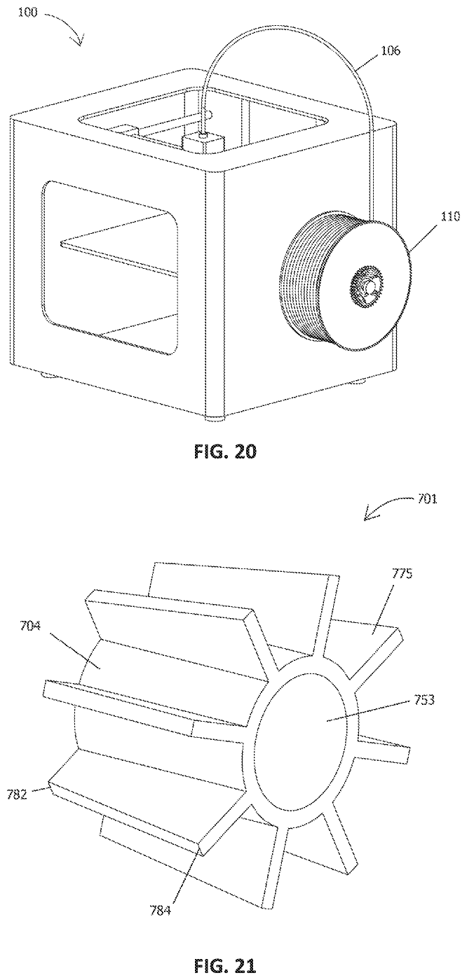

In an embodiment, device 600 may be mounted on a side of a printer housing, such as the housing of 3D printer 100, as illustrated in FIG. 20. Device 600 may be integrated with a 3D printer.

In alternative embodiments, couplers 501 and 601 may be replaced with a coupler 701 as illustrated in FIG. 21. Coupler 701 is similar to coupler 501 in that couple 701 also has a general overall cone-shaped profile or a tapered outer surface with a plurality of teeth 775. However, unlike coupler 501 or 601, teeth 775 of coupler 701 are formed on a cylindrical sleeve 704, which defines an inner bore 753. Bore 753 is shaped and sized similar to central bore 353 of coupler 501, for receiving and frictionally engaging a bushing 508. Teeth 775 may be shaped and sized similar to teeth 375.

In the embodiment illustrated in FIG. 21, the outer surface of sleeve 704 is cylindrical and the teeth 775 are tapered from one end, e.g. end 782, toward the other end, e.g. end 784. Each tooth 775 is taller at end 784 than at end 782. As a result, the outer edge of each tooth 775 is further away from the central axis of coupler 775 at end 784 than at end 782. Thus, the outer surface of coupler 701 is generally cone-shaped.

In an alternative embodiment, the sleeve 704 may have a conical outer surface and the teeth 775 may be tapered or have uniform heights from end 782 to end 784. The overall profile of the coupler 701 in such a configuration is still conical or generally cone shaped.

For clarification, it is noted that in this disclosure, when directional orientations such as “above”, “below”, “top”, “bottom”, and the like are made with reference to a 3D printer, it is assumed that the 3D printer is oriented in the normal operation (printing) position.

R should also be understood that modifications and variations to the specific embodiments described above are possible.

### CONCLUDING REMARKS

It will be understood that any range of values herein is intended to specifically include any intermediate value or sub-range within the given range, and all such intermediate values and sub-ranges are individually and specifically disclosed.

It will also be understood that the word “a” or “an” is intended to mean “one or more” or “at least one”, and any singular form is intended to include plurals herein.

It will be further understood that the term “comprise”, including any variation thereof, is intended to be open-ended and means “include, but not limited to,” unless otherwise specifically indicated to the contrary.

When a list of items is given herein with an “or” before the last item, any one of the listed items or any suitable combination of two or more of the listed items may be selected and used.

Of course, the above described embodiments of the present disclosure are intended to be illustrative only and in no way limiting. The described embodiments are susceptible to many modifications of form, arrangement of parts, details and order of operation. The invention, rather, is intended to encompass all such modification within its scope, as defined by the claims.

What is claimed is:

1. A device for supporting filament spools in additive manufacturing systems, comprising:
a rigid axle sized to pass through a central passageway of a filament spool, the axle comprising first and second ends and a cylindrical central section extending between the first and second ends, at least one of the first and second ends configured to be supported on a support structure that supports the axle and the filament spool and restricts rotation of the axle;
first and second bushings formed of a rigid material, the first and second bushings sized to rotatably fit over the central section of the axle; and
first and second couplers for coupling the first and second bushings, respectively, to the central passageway of the filament spool, the first and second couplers formed of a resiliently deformable material, wherein each one of the first and second couplers has a tapered outer surface comprising a plurality of teeth for frictionally engaging one of first and second open ends of the central passageway of the filament spool, and has a central bore for receiving and frictionally engaging one of the first and second bushings.

2. The device of claim 1, wherein the support structure comprises a base body, and two arms extending from the base body each for supporting one of the first and second ends of the axle.

3. The device of claim 1, wherein the teeth are straight bevel gear teeth.

4. The device of claim 3, wherein each one of the first and second couplers has an outer diameter from 10 mm to 120 mm.

5. The device of claim 1, wherein the resiliently deformable material has a Shore hardness less than 95A.

6. The device of claim 1, wherein the rigid material of the first and second bushings has a Shore hardness of more than 75D.

7. The device of claim 6, wherein the rigid material is one of nylon, aluminum, steel, and copper.

8. The device of claim 1, wherein each one of the first and second bushings comprises a cylindrical central channel.

9. The device of claim 8, wherein the central channel has a diameter of from 6 mm to 80 mm.

10. The device of claim 1, wherein the axle is configured to be supported at one of the first and second ends of the axle.

11. The device of claim 1, wherein the axle is configured to be supported at both of the first and second ends.

12. The device of claim 2, wherein the base body comprises a plurality of through holes for mounting the base body.

13. The device of claim 2, wherein each one of the first and second arms comprises a plurality of slots, each one of the slots configured to receive and support one of the first and second ends of the axle.

14. The device of claim 13, wherein at least one of the slots is oriented and configured to support the axle above the base body when the first and second arms are vertically oriented.

15. The device of claim 13, wherein at least one of the slots is oriented and configured to support the axle at a side of the base body when the first and second arms are horizontally oriented.

16. The device of claim 13, wherein at least one of the slots is oriented and configured to support the axle below the base body when the first and second arms are inversely vertically oriented.

17. The device of claim 2, wherein the support structure comprises a rigid material selected from an alloy, steel, aluminum, and a plastic material.

18. The device of claim 2, wherein the support structure comprises a generally U-shaped panel having a thickness of from 0.5 mm to 20 mm.

19. The device of claim 1, wherein the tapered outer surface of each one of the first and second couplers comprises a plurality of teeth for engaging the open end of the filament spool.

20. A support structure for supporting the device of claim 1, comprising:
a rigid panel bent into a generally U-shaped profile, comprising a central base body and two arms extending from the base body, a terminal end of each one of the arms comprising a plurality of slots configured to engage and support one of the first and second ends of the axle,
wherein
the base body comprising a plurality of through holes for mounting the base body;
at least one of the slots is configured to support the axle above the base body when the first and second arms are vertically oriented;
at least one of the slots is oriented and configured to support the axle below the base body when the first and second arms are inversely vertically oriented; and
at least one of the slots is oriented and configured to support the axle at a side of the base body when the first and second arms are horizontally oriented.
